(19) United States
(12) Patent Application Publication
(10) Pub. No.: US 2024/0210030 A1
(43) Pub. Date: Jun. 27, 2024

(54) REFORMER BURNER FOR UNIFORM GAS BLENDING

(71) Applicant: MOONHWA GAS & ENERGY CONSTRUCTION CO., LTD., Yongin-si (KR)

(72) Inventors: Won Yong KIM, Yongin-si (KR); K. Y. CHO, Yongin-si (KR); Kyumin CHO, Yongin-si (KR); Ga Ram PYO, Yongin-si (KR); Jong Mook KANG, Yongin-si (KR)

(21) Appl. No.: 18/496,498

(22) Filed: Oct. 27, 2023

(30) Foreign Application Priority Data
Dec. 22, 2022 (KR) 10-2022-0181938

(51) Int. Cl. F23D 14/22; F23D 14/82

(52) U.S. Cl. CPC F23D 14/22; F23D 14/82; F23D 2206/00

(57) ABSTRACT

As a reformer burner for heating a reformer of a fuel cell, there is provided a reformer burner including a body in a form of extending in one direction; an anode off-gas supply unit that is provided on a side of the body and that supplies anode off-gas; a fuel gas supply unit that is provided on the body on a side opposite to the side provided with the anode off-gas supply unit and that supplies fuel gas; a separation member that is provided inside the body; and a nozzle unit that is provided in the chamber and that sprays flame, in which the nozzle unit, the anode off-gas supply unit, and the fuel gas supply unit are separated in the body by the separation member. The separation member includes a separation membrane that is provided inside the body and that blocks flow of the anode off-gas and the fuel gas; and a uniform distribution pipe that penetrates the separation membrane, and the uniform distribution pipe has an inlet on the body above a position where the anode off-gas supply unit is provided and a position where the fuel gas supply unit is provided, and an outlet in a region opposite to the region where the inlet is provided based on the separation membrane.

### PRIORITY CLAIM

The application claims the benefit of KR Patent Application Serial No. 10-2022-0181938 filed on Dec. 22, 2022; the disclosure of this application is hereby incorporated herein by reference.

### TECHNICAL FIELD

The present disclosure relates to a reformer burner capable of uniformly blending fuel gas and anode off-gas and providing the blended gas.

### BACKGROUND INFORMATION

A fuel cell is a compact cogeneration system that directly converts chemical energy into electrical energy through a chemical reaction of oxygen with hydrogen contained in hydrocarbon-based materials such as methanol, ethanol, and natural gas.

The polymer electrolyte membrane fuel cell (PEMFC) system is a high-efficiency next-generation distributed power generation system that produces electricity and heat through an electrochemical reaction of hydrogen with air. Such fuel cell system consists of a reformer, a stack, and an inverter as main parts, and is additionally equipped with balance of plant (BOP) and the like. The stack of fuel cell has a structure in which several to tens of unit cells including a membrane electrode assembly (MEA) and a separator are stacked. The reformer is composed of a steam reforming (SR) reaction unit, a water-gas shift (WGS) reaction unit, and a preferential oxidation (Prox) reaction unit.

Hydrogen generated in the reformer is supplied to the anode electrode of the PEMFC stack, and undergoes an electrochemical reaction with oxygen supplied to the cathode electrode to produce electricity in the stack.

Since the steam reforming reaction in the reformer is conducted at a high temperature, a reformer burner is equipped as a means for supplying necessary heat to the fuel processing apparatus. A reformer burner basically burns fuel gas to generate heat, and the fuel at this time generally contains hydrocarbon-based city gas such as

LNG or LPG as the main component. However, in order to improve the efficiency of the PEMFC system, the burner is required to be capable of burning not only city gas but also anode off-gas (AOG). In other words, it is necessary that means be provided for burning hydrogen gas, which is the main component of the anode off-gas that is unreacted in and discharged from the PEMFC stack. This means that the hydrogen gas utilization rate in the PEMFC stack is generally about 70% to 85%, and at this time, it is required that the hydrogen gas remaining after use in the stack not be discharged out of the stack and discarded. Therefore, when the remaining hydrogen gas is recovered and used as fuel for the reformer burner, the overall efficiency of the power generation system can be improved. In other words, a fuel cell is a cell that directly converts chemical energy produced by oxidation of fuel into electrical energy, and can be referred to as a chemical cell that produces electricity using an oxidation/reduction reaction at electrodes, but is different from a general chemical cell in that a reactant is continuously supplied into the system where a reaction takes place.

FIG. 1 illustrates a block diagram of a conventional fuel cell system 1. As illustrated in FIG. 1, such a polymer electrolyte membrane fuel cell system 1 largely consists of a reformer 2 and a fuel cell stack 6, and the reformer 2 is configured to include a steam reforming reaction unit 3 that converts general fuel such as LPG, LNG, methane, and coal gas methanol, which chemically contain hydrogen, into gas containing a large amount of hydrogen required by the fuel cell; a water-gas shift reaction unit 4 that lowers the CO concentration by reacting the reformed gas generated in the reformer with water; a preferential oxidation reaction unit 5 that removes the CO composition that causes poisoning of the PEMFC electrode to 10 ppm or less; a burner 100 that heats the steam reforming reaction unit 3 to promote a chemical catalytic reaction in the steam reforming reaction unit 3; and a fuel supply unit that supplies fuel into the burner 100.

However, in the fuel cell system configured as described above, the reformer burner uses not only city gas but also anode off-gas containing hydrogen gas as fuel to improve the overall efficiency of the system. In blending and burning these two types of gases and combustion air, city gas and air are supplied into the burner unit through a confluence pipe and a separate anode off-gas pipe, and burning occurs in a state in which the gas and air are not uniformly blended, and there is a problem such as unevenness of the flame. In addition, since uniform temperature distribution cannot be maintained in the entirety of the burner unit because of the incomplete burning of the city gas and anode off-gas and air, as a result, there is also a problem of discharging exhaust gas containing CO at a high concentration. Moreover, the incomplete burning as above also has a problem of causing a decrease in the overall performance and thermal efficiency of the reformer.

### SUMMARY

The present disclosure relates to a reformer burner configured to uniformly blend and burn an anode off-gas and a fuel gas.

According to an embodiment of the present disclosure, there is provided a reformer burner including a body in a form of extending in one direction; an anode off-gas supply unit that is provided on a side of the body and that supplies anode off-gas; a fuel gas supply unit that is provided on the body on a side opposite to the side provided with the anode off-gas supply unit and that supplies fuel gas; a separation member that is provided inside the body; and a nozzle unit that is provided in the chamber and that sprays flame, in which the nozzle unit, the anode off-gas supply unit, and the fuel gas supply unit are separated in the body by the separation member, the separation member includes a separation membrane that is provided inside the body and that blocks flow of the anode off-gas and the fuel gas; and a uniform distribution pipe that penetrates the separation membrane, and the uniform distribution pipe has an inlet on the body above a position where the anode off-gas supply unit is provided and a position where the fuel gas supply unit is provided, and an outlet in a region opposite to the region where the inlet is provided based on the separation membrane.

According to an embodiment of the present disclosure, there is provided a reformer burner in which a flashback arrestor is provided inside the body, and the flashback arrestor is provided between a nozzle end and the separation membrane.

According to an embodiment of the present disclosure, there is provided a reformer burner in which the flashback arrestor has a structure in which metal mesh sheets are layered.

According to an embodiment of the present disclosure, there is provided a reformer burner in which the uniform distribution pipe is provided in a central region of the body.

According to an embodiment of the present disclosure, there is provided a reformer burner in which the outlet of the uniform distribution pipe is provided adjacent to the separation membrane.

According to an embodiment of the present disclosure, there is provided a reformer burner in which the reformer burner is a reformer burner for heating a reformer of a fuel cell.

According to an embodiment of the present disclosure, anode off-gas and fuel gas can be uniformly blended by utilizing a mechanical structure and fluid flow without a separate blending device and used for burning.

### BRIEF DESCRIPTION OF DRAWINGS

FIG. 1 illustrates a block diagram of a conventional fuel cell system.

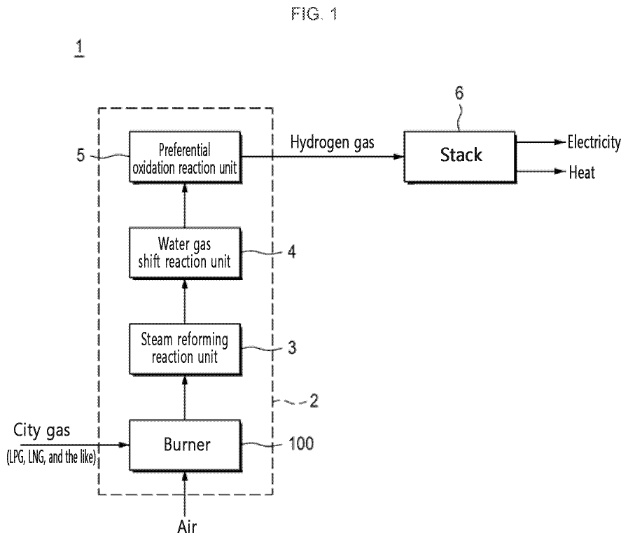

FIG. 2 illustrates a side view of a reformer burner according to an embodiment of the present disclosure.

FIG. 3 illustrates a rear view of a reformer burner according to an embodiment of the present disclosure.

FIG. 4 illustrates a cross-sectional view of a reformer burner according to an embodiment of the present disclosure.

### DETAILED DESCRIPTION

The present disclosure may have various changes and various forms, and specific embodiments are illustrated in the drawings and described in detail in the text. However, it should be understood that this is not intended to limit the present disclosure to the specific forms disclosed, and includes all changes, equivalents, and substitutes included in the spirit and scope of the present disclosure.

In this specification, when one constituent is referred to as being on another constituent, it means that one constituent may be formed directly on another constituent or a third constituent may be interposed therebetween. In the drawings, the thicknesses of constituents are exaggerated for effective explanation of technical content.

Embodiments described in this specification will be explained with reference to cross-sectional views and/or plan views, which are ideal exemplary views of the present disclosure. In the drawings, the thicknesses of membranes and regions are exaggerated for effective explanation of technical content. Accordingly, the shape of the illustrated drawings may be modified by manufacturing techniques and/or tolerances. Therefore, embodiments of the present disclosure are not limited to the specific shapes illustrated, but also include changes in shapes generated according to manufacturing processes. For example, a region illustrated at right angles may have a shape that is rounded or has a predetermined curvature. Accordingly, the regions illustrated in the drawings have attributes, and the shapes of the regions illustrated in the drawings are intended to illustrate a specific shape of a region of a device and are not intended to limit the scope of the present disclosure. Although terms such as first and second are used to describe various constituents in various embodiments of the present specification, these constituents should not be limited by these terms. These terms are only used to distinguish one constituent from another constituent. Embodiments described and illustrated herein also include complementary embodiments thereof.

Terms used in this specification are for explaining embodiments and are not intended to limit the present disclosure. In this specification, singular forms also include plural forms unless otherwise specifically stated in a phrase. The terms “comprises” and/or “comprising” used in the specification do not exclude the presence or addition of one or more constituents other than the mentioned constituent.

In describing the specific embodiments below, various specific contents are written to explain the present disclosure in more detail and aid understanding. However, readers who have sufficient knowledge in this field to understand the present disclosure can recognize that the present disclosure can be used without these various specific details. It is mentioned in advance that parts that are commonly known in describing the present disclosure and are not greatly related to the present disclosure are not described in order to prevent confusion for no particular reason in explaining the present disclosure in some cases.

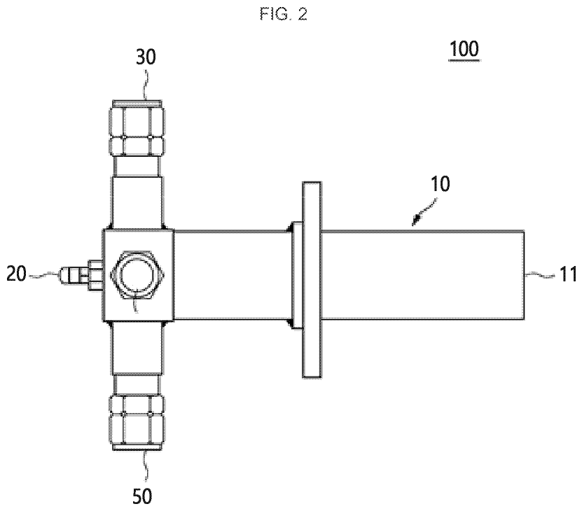

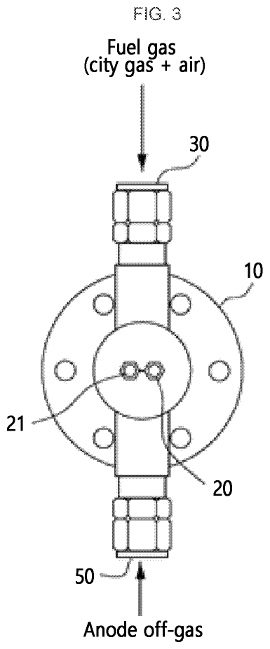

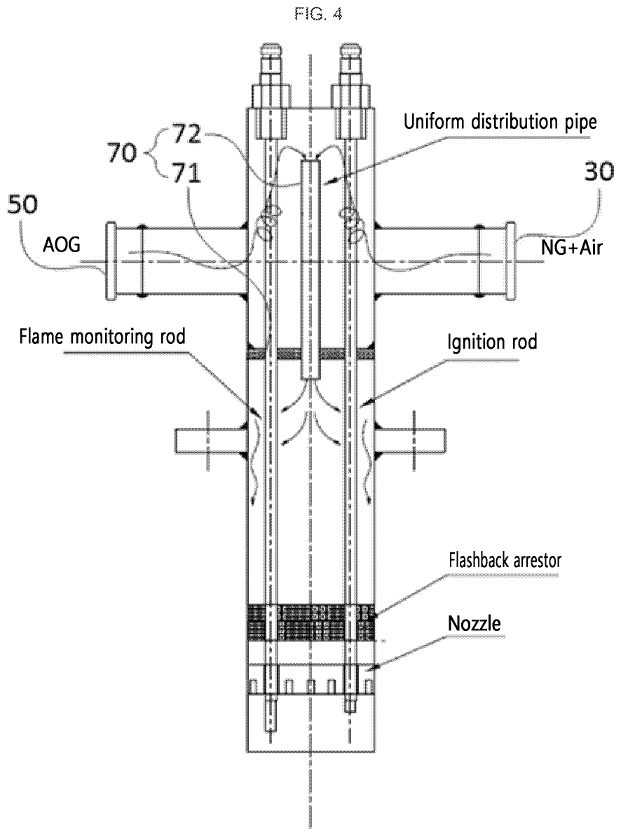

First, FIG. 2 illustrates a side view of a reformer burner according to an embodiment of the present disclosure, FIG. 3 illustrates a rear view of a reformer burner according to an embodiment of the present disclosure, and FIG. 4 illustrates a cross-sectional view of a reformer burner according to an embodiment of the present disclosure.

As illustrated in FIGS. 2 to 4, a reformer burner 100 according to an embodiment of the present disclosure may be configured to include a body 10, a nozzle unit, an ignition device 20, a flame monitoring device 21, a separation member 70, a flashback arrestor 80, and the like as a whole.

The body 10 may be configured in a tubular shape having an open end 11 on the front side as a whole, and a fuel gas supply unit 30 and an anode off-gas supply unit 50 are equipped on the rear side face.

The fuel gas supply unit 30 is a part to which fuel gas, which is a mixture of air and city gas such as LPG or LNG, is supplied. A city gas supply unit and an air supply unit may be configured separately, but in an embodiment of the present disclosure, the fuel gas, in which city gas supplied from the city gas supply unit and air supplied from the air supply unit are blended at a pre-set ratio, is supplied into the burner through the fuel gas supply unit.

The anode off-gas supply unit 50 is a part to which anode off-gas, the main component of which is hydrogen gas remaining after use in a fuel cell stack 6, is supplied. A space for pre-blending into which the fuel gas and the anode off-gas are introduced and blended is provided at the rear of the internal space of the burner. The supply direction of the fuel gas supply unit 30 and the supply direction of the anode off-gas supply unit 50 may be opposite to each other.

The space for pre-blending is provided to more uniformly blend the fuel gas supplied from the fuel gas supply unit 30 and the anode off-gas supplied from the anode off-gas supply unit 50. The space for pre-blending is provided at the rear end of the burner 100 and is provided separately from the front end. Accordingly, the separation member 70 is provided in the burner 100 to separate the space for pre-blending from the front space of the burner 100.

The separation member 70 includes a separation membrane 71 that separates gases so that the gases cannot flow and a uniform distribution pipe 72 provided in a form penetrating the separation membrane 71. The diameter of the uniform distribution pipe 72 is smaller than the diameter of the burner 100. The uniform distribution pipe 72 may have a shape extending long along the extension direction of the burner 100. One end of the uniform distribution pipe 72 (the outlet of the uniform distribution pipe 72) may be provided beyond the separation membrane 71, and the other end (the inlet of the uniform distribution pipe 72) may be provided inside the separation membrane 71, that is, in a space where gas is supplied from the fuel gas supply unit 30 and the anode off-gas supply unit 50. In particular, the inlet of the uniform distribution pipe 72 may be provided away from the separation membrane 71, and may be specifically provided above the fuel gas supply unit 30 and the anode off-gas supply unit 50. Accordingly, the gas supplied from the fuel gas supply unit 30 and the anode off-gas supply unit 50 cannot be directly introduced into the inlet of the uniform distribution pipe 72, but is filled and blended in the space for pre-blending of the burner 100 and then blended into the uniform distribution pipe 72.

In particular, the supply direction of the fuel gas supply unit 30 and the supply direction of the anode off-gas supply unit 50 are disposed opposite to each other and the uniform distribution pipe 72 is provided at a high point where the fuel gas supplied from the fuel gas supply unit 30 and the anode off-gas supplied from the anode off-gas supply unit 50 meet so that the fuel gas and the anode off-gas may be uniformly blended and then supplied for burning. Specifically, the fuel gas and the anode off-gas introduced in opposite directions collide with each other in the region where the uniform distribution pipe 72 is provided by the flow velocity imparted along the pipe. After the collision, the fuel gas and the anode off-gas are continuously blended in the burner 100 by the inertia of continuing to flow in the directions in which the fuel gas and the anode off-gas are supplied along the pipe. However, after the two types of gases collide, the flow due to the inertial force quickly weakens, and fuel gas and anode off-gas at high flow velocities are continuously supplied in the inlet region where the fuel gas supply unit 30 and the anode off-gas supply unit 50 are connected, and thus it does not happen that the fuel gas continues to flow and is introduced beyond the anode off-gas supply unit 50 or the anode off-gas continues to flow and is introduced beyond the fuel gas supply unit 30. However, since the two gases can be uniformly blended using the flow inertia when the two types of fluids collide head-on in this way, and uniform gas blending is possible in a case where the fuel gas supply unit 30 and the anode off-gas supply unit 50 are disposed to face each other compared to a case where the fuel gas supply unit 30 and the anode off-gas supply unit 50 are disposed side by side or vertically.

The uniform distribution pipe 72 is provided at the center of the region where the two types of gases collide, that is, at the center of the body, and the inlet of the uniform distribution pipe 72 is located inside the inlet region where the fuel gas supply unit 30 and the anode off-gas supply unit 50 are connected, as a result, the blended gas can be introduced into the inlet of the uniform distribution pipe 72 only after the gases are blended by the above-mentioned collision and the stable gas mixture is sufficiently filled in the space for pre-blending of the burner.

The outlet of the uniform distribution pipe 72 is provided outside the separation membrane 71, that is, beyond the space where gases are supplied from the fuel gas supply unit 30 and the anode off-gas supply unit 50 based on the separation membrane 71. The outlet of the uniform distribution pipe 72 may be provided adjacent to the separation membrane 71. Accordingly, the length of the space in which the blended gas that flows along the uniform distribution pipe 72 having a relatively narrow diameter and is introduced beyond the separation membrane 71 spreads after exiting the uniform distribution pipe 72 may be increased. In a case where the outlet of the uniform distribution pipe 72 extends along the body 10 to a region far away from the separation membrane 71, gas may be burned by the nozzle as soon as it comes out from the outlet. In this case, the gas has a high propensity to flow along the machine direction of the body 10 and a low propensity to spread along the transverse direction of the body 10, and can be supplied into the nozzle in a narrow and thin form at a high flow velocity.

In this case, the gas may be supplied to a specific region and the burning form may be different from the desired one. However, in a case where the outlet of the uniform distribution pipe 72 is provided adjacent to the separation membrane 71, there is a sufficient free space for the gas flowing out along the pipe to spread in the transverse direction of the body 10. Therefore, when the blended gas reaches the nozzle, the flow velocity and the gas distribution can reach appropriate levels.

The reformer burner 100 may be configured to further include a bypass supply unit that is connected to a side of a hydrogen supply terminal through which hydrogen is supplied to the fuel cell stack 6 and introduces hydrogen gas not used in the fuel cell stack 6 into the anode off-gas supply unit 50 side. In addition, a nozzle unit is equipped inside the open end 11 to spray flame forward, and the ignition device 20 is coupled thereto to penetrate so that the ignition rod of the spark plug protrudes in front of the nozzle unit. The reformer burner 100 is configured to monitor the flame formed in the nozzle unit in real time through the flame monitoring device 21.

A flashback arrestor is installed at the rear end of the nozzle unit 12 and at the front side of the internal space 13 to prevent flashback of the flame. Such a flashback arrestor has a structure in which metal mesh sheets formed of a metal material such as SUS or Ni are layered. Such a structure may perform a function of additionally blending the gases.

The control unit may be configured to collectively control the fuel gas supply unit 30, the city gas supply unit, the air supply unit, the anode off-gas supply unit 50, the bypass supply unit, and the ignition device 20 of the burner.

In other words, the flow rate of the blended gas supplied into the burner can be adjusted by controlling the fuel gas supply unit 30, the blending ratio of city gas to air in the fuel gas can be adjusted by controlling the city gas supply unit and the air supply unit, and the flow rate of hydrogen gas supplied into the burner can be adjusted by controlling the anode off-gas supply unit 50 and the bypass supply unit.

The control unit can receive the flame detection signal measured by the flame monitoring device 21 in real time, and can control to immediately cut off fuel supply through the blended gas supply unit 30 when the flame of the burner 100 is turned off.

Although the above has been described with reference to preferred embodiments of the present disclosure, those skilled in the art or those having ordinary knowledge in the art will understand that the present disclosure can be variously modified and changed without departing from the spirit and technical scope of the present disclosure described in the claims to be described later.

Therefore, the technical scope of the present disclosure is not limited to the contents described in the detailed description of the specification, but should be defined 5 by the claims. CLAIMS

1. A reformer burner, comprising:
a body in a form of extending in one direction;
an anode off-gas supply unit that is provided on a side of the body and that supplies anode off-gas;
a fuel gas supply unit that is provided on the body on a side opposite to the side provided with the anode off-gas supply unit and that supplies fuel gas;
a separation member that is provided inside the body; and
a nozzle unit that is provided in the chamber and that sprays flame,
wherein the nozzle unit, the anode off-gas supply unit, and the fuel gas supply unit are separated in the body by the separation member,
wherein the separation member includes a separation membrane that is provided inside the body and that blocks flow of the anode off-gas and the fuel gas; and a uniform distribution pipe that penetrates the separation membrane, and
wherein the uniform distribution pipe has an inlet on the body above a position where the anode off-gas supply unit is provided and a position where the fuel gas supply unit is provided, and an outlet in a region opposite to the region where the inlet is provided based on the separation membrane.

2. The reformer burner according to claim 1, further comprising:
a flashback arrestor is provided inside the body, the flashback arrestor provided between a nozzle end and the separation membrane.

3. The reformer burner according to claim 2, wherein the flashback arrestor has a structure in which metal mesh sheets are layered.

4. The reformer burner according to claim 1, wherein the uniform distribution pipe is provided in a central region of the body.

5. The reformer burner according to claim 1, wherein the outlet of the uniform distribution pipe is provided adjacent to the separation membrane.

6. The reformer burner according to claim 1, wherein the reformer burner is a reformer burner for heating a reformer of a fuel cell.
